(19) United States
(12) Patent Application Publication
(10) Pub. No.: US 2010/0131582 A1
(43) Pub. Date: May 27, 2010

(54) Unified Proxy Location Selection Mechanism

(75) Inventors: Daniel J. Driscoll, Bellevue, WA (US); Daniel L. Conti, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/275,897

(22) Filed: Nov. 21, 2008

(51) Int. Cl. G06F 15/16

(52) U.S. Cl. 709/202; 709/227; 709/230

(57) ABSTRACT

Various embodiments enable network users to efficiently discover network proxies. A computing device may employ various techniques to discover and collect network proxies from various network domains. A user, through a network client or network device, can select one or more proxies from the collected proxies and then query the selected proxies for information related to a network service or resource. The user can then select a network service or resource based in part on the proxy information.

### BACKGROUND

In general, a computer network is a group of computing devices that communicate over a network. Computer networks may be classified according to their network topology such as, for example, a bus network, a ring network, a mesh network, a hierarchical tree network, and the like. Computer networks may also be classified according to the functional relationship that exists between the network elements such as client-server, peer-to-peer, active networking, etc.

One advantages of joining or belonging to a computer network is the ability to use services and resources that reside on the network (e.g., printing services, storage services, software libraries, etc.). For example, a client device may employ a computer network to communicate with the various computing devices on the network, use a network printing device, access data files or software residing on a network server, or connect to the Internet, to name a few.

One issue with belonging to a computer network pertains to the difficulty in discovering services and resources that reside on the network. This can be particularly problematic when the network is large (e.g., hundreds or thousands of computing devices), when the network is distributed over a large area (e.g., different locations or organizations), and/or when the network contains many administrative domains.

Historically, network users have relied on manual discovery, ad-hoc broadcasting protocols, and/or a centralized discovery database to discover or identify network services or resources.

Manual discovery generally involves manually entering a resource's name (e.g., a printer's domain name) into a network browser to discover or access the network resource. While manual discovery works well when a network is small and the resources residing on the network are known to the user, manual discovery can be problematic when the network is large, consists of several network domains, and/or the network's services and resources are unknown to the user.

Alternatively, a network user may employ ad-hoc broadcasting (e.g., Network Basic Input/Output System, Web Services Dynamic Discovery, Simple Service Discovery Protocol, and the like) to discover the services and resources that may reside on a network. A computing device employing ad-hoc broadcasting typically sends out a network query and listens on the network for the network device's response. In general, ad-hoc broadcasting works well when the network consists of a single subnet (e.g., collection of computing devices that do not require a router to communicate) and the number of network devices is relatively small. However, ad-hoc discovery typically consumes a great deal of bandwidth when the number of network resources is large or the network resources are scattered over various network domains. Moreover, ad-hoc discovery mechanisms are unable to scale to the size of a large company or organization.

Finally, a network user may use a centralized discovery database to identify services and resources that reside on a network. Typically, a network administrator builds a directory of network services and resources that the members of a network can access and use. While network directories are an efficient means of enabling network users to discover and utilize a network's resources, such directories can be expensive to create, operate, and maintain. Specifically, a system administrator typically creates the network directory, updates the directory when resources are added or removed from the network, and administers who is given access to the directory. In addition, a network user typically requires some form of credential (e.g., user name and password) to access and use the network's services and resources.

While each of these techniques is capable of detecting network services and resources there is room for improvement.

### SUMMARY

This Summary is provided to introduce a selection of concepts in a simplified form that are described below in the Detailed Description. This Summary is not intended to identify key or essential features of the claimed subject matter, nor is it intended to limit the scope of the claimed subject matter.

Various embodiments enable network users to efficiently discover network proxies. A computing device may employ various techniques to discover and collect network proxies. A user, through a network client or client device, can select one or more proxies from the collected proxies and then query the selected proxies for information regarding a network service or resource. The user can then select a network service or resource based in part on the proxy information.

### BRIEF DESCRIPTION OF THE DRAWINGS

The same numbers are used throughout the drawings to reference like features.

FIG. 1 illustrates an operating environment in which the inventive principles can be employed in accordance with one or more embodiments.

FIG. 2 illustrates a unified proxy location module in accordance with one or more embodiments.

FIGS. 3 and 4 are flow diagrams describing steps in a method of ad-hoc network discovery in accordance with one or more embodiments.

FIG. 5 is flow diagram describing steps in a method of discovering network proxies in accordance with one or more embodiments.

FIG. 6 is a block diagram of a computing device in accordance with one or more embodiments.

### DETAILED DESCRIPTION

Overview

Various embodiments enable network users to efficiently discover network proxies. A network proxy is generally any network or infrastructure component that enables a user, through a network client or client device, to discover network services and/or resources.

In at least some embodiments, a unified proxy location module, residing on a computing device, employs various techniques to discover network proxies. The unified proxy location module may then store the proxies for later use. A network user, a network browser, or a software application may select one or more of the stored proxies to acquire information related to network services or resources. The computing device may then query the selected proxies for network services information and present the information. The network user, browser, or application may then select a network service or resource based upon the proxy information.

In the discussion that follows, a section entitled “Operating Environment” describes a computing environment in which the various embodiments can be employed. Following this, a section entitled “Unified Proxy Location Module” describes an embodiment in which a unified proxy location module enables a network user to efficiently search for network proxies. Lastly, a section entitled “Example System” describes an example system that can be used to implement one or more embodiments.

Operating Environment

When working in a networked computing environment, a user is typically behind a proxy server (e.g., a client device typically communicates with a proxy server which communicates with an external network). In other words, the proxy server acts as a gateway between the user and an external network, such as the Internet and proxies all web traffic exiting an administrative domain. In contrast, a discovery proxy generally enables a user or client device to discover network services and resources.

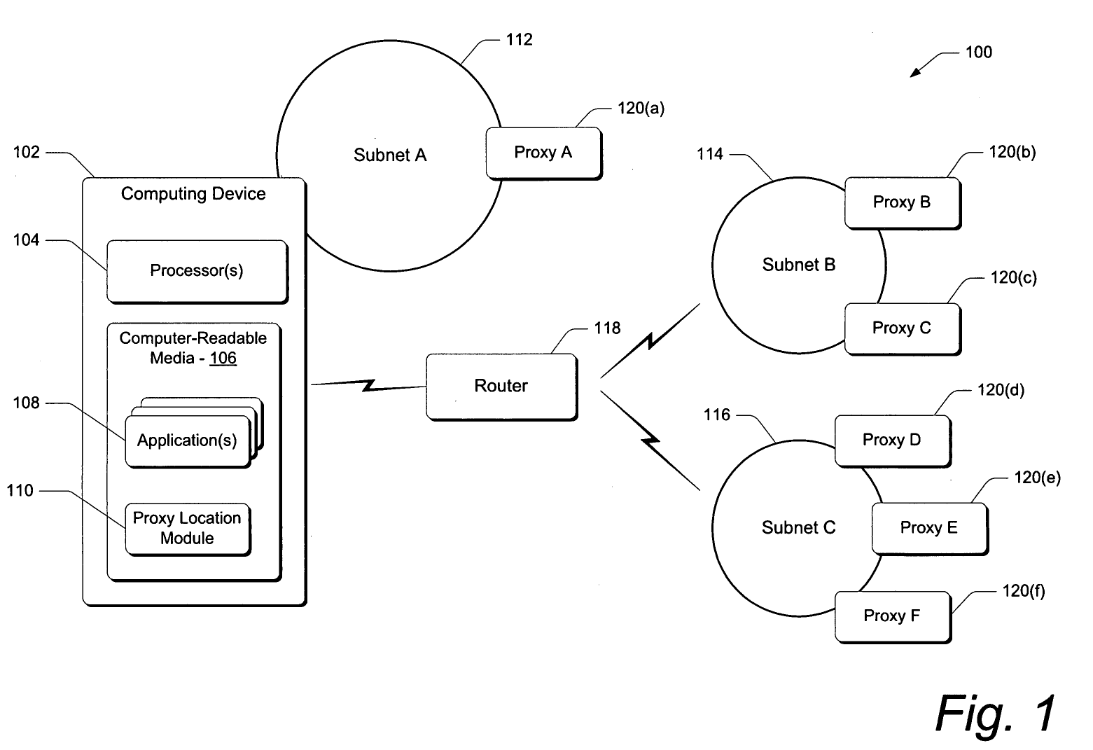

FIG. 1 illustrates an operating environment 100 in accordance with one or more embodiments. Operating environment 100 may include a computing device 102 having one or more processors 104, one or more computer-readable media 106, one or more applications 108 which may reside on the computer-readable media 106 and which may be executed by the processor 104, and a unified proxy location module (UPLM) 110 for discovering network proxies. The operating environment 100 may also include one or more networks including Subnet A 112 which communicates directly with the computing device 102 (i.e., no network router or switching device), and Subnets B 114 and C 116, which communicate with the computing device 102 through one or more network router(s) 118 and/or switching devices. In addition, each of the Subnets may include one or more proxies. For example, Subnet A includes proxy 120(a), Subnet B includes proxies 120(b) and 120(c), and Subnet C includes proxies 120(d), 120(e), and 120(f).

The term “proxy” may include any network or infrastructure component that enables a user, through a network client or client device, to discover network services and/or resources. By way of example and not limitation, a proxy may include and/or be embodied on a personal computing device (e.g., desktop computer, laptop computer, personal digital assistant, cell phone, handheld device, etc.), a printing device (e.g., desktop printer, copier, large format printer, multi-function device, etc.), a storage device (e.g., server, server farm, disc drive, or other storage device), and/or a computing device that hosts or provides a network service or resource (e.g., E-mail server, multimedia server, address book, billing service, to name a few). In addition, a proxy may exist in one or more software applications, such as applications 108.

As noted, the computing device 102 may communicate directly with one or more proxies over a local area network (LAN). For example, computing device 102 may communicate directly with Proxy A 120(a) over Subnet A 112. Alternately or additionally, the computing device 102 may communicate with various proxies over various subnets or network domains through a router or other switching device. For example, computing device 102 may communicate with the various proxies (i.e., Proxies 120b-f) distributed over Subnet B and Subnet C via one or more router(s) 118 or switching devices.

It should be appreciated that computing device 102 can be embodied as any suitable computing device such as, by way of example and not limitation, a desktop computer, a portable computer, a personal digital assistant (PDA), a cell phone, and the like.

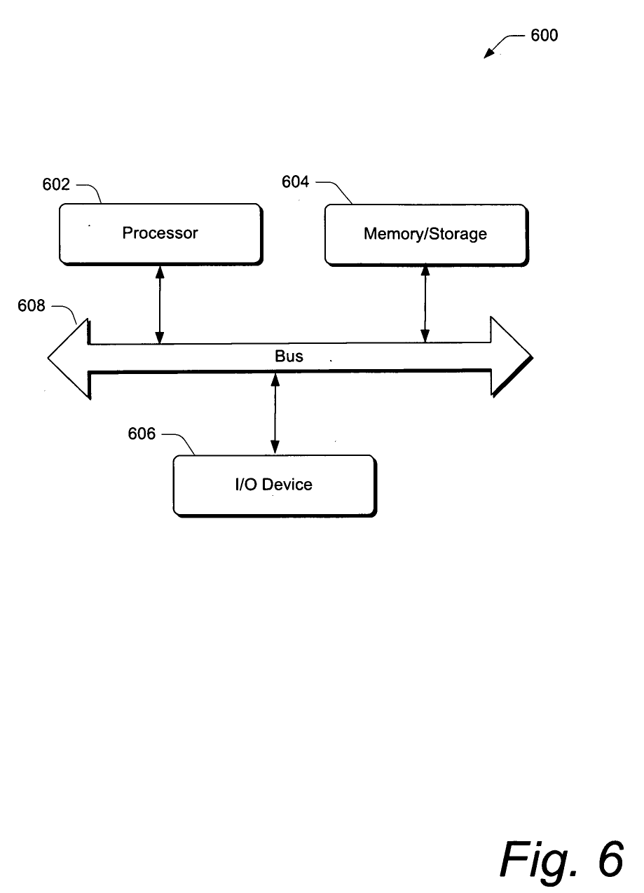

Computer-readable media 106 may include, by way of example and not limitation, all forms of volatile and non-volatile memory and/or storage media that are typically associated with a computing device. Such media can include read only memory (ROM), random access memory (RAM), flash memory, hard disk, removable media and the like. One specific example of a computing device is shown and described in FIG. 6.

Applications 108 may include any suitable type of software application such as, by way of example and not limitation, an E-mail application, an instant messaging application, a word processing application, a spread sheet application, a graphical illustration application, a media player application, and the like.

The proxy location module 110 may be configured as a software application residing in memory 106 which enables a user to efficiently discover network proxies and services with little user intervention or involvement (e.g., without manually searching for a network proxy, maintaining a directory of network proxies, or entering a proxy's network address in a browser).

Having considered an example operating environment 100, consider now a discussion of an example unified proxy location module in accordance with one or more embodiments.

Unified Proxy Location Module

In one or more embodiments, a unified proxy location module enables a network user, through a network client or client device, to efficiently discover network proxies.

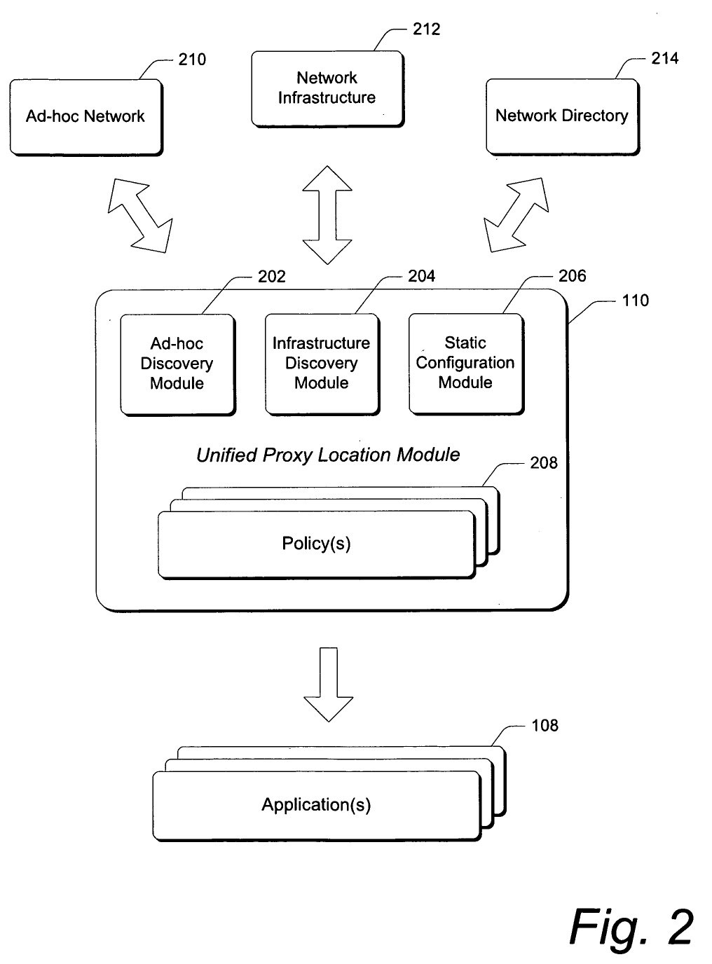

FIG. 2 illustrates a unified proxy location module (UPLM) 110 in accordance with one or more embodiments. The UPLM 110 can employ various techniques to discover network proxies. In some embodiments, the UPLM 110 may include an ad-hoc discovery module 202, an infrastructure discovery module 204, a static configuration module 206, and various policies 208 for managing communications between the UPLM 110 and various network proxies. FIG. 2 also illustrates various network components that may communicate with the UPLM 110 such as, by way of example and not limitation, members of an ad-hoc network 210 (e.g., Proxy A of Subnet A), infrastructure components of a network 212 (e.g., Proxies B-F of Subnets B and C), and components listed in a network directory 214. Finally, application(s) 108 can comprise software applications that employ or otherwise utilize various network services and resources. For example, application 108 may include an E-mail application which communicates with an E-mail server that resides on a business's wide area network. Hence, the UPLM serves as an aggregating conduit for administrative and environmental information. The UPLM may query network services for information (e.g., “are there any proxies out there?”); it may also receive directives from an administrator (e.g., “all UPLMs should look for proxies at this address . . . ”).

In general operation, in at least some embodiments, the UPLM 110 employs the ad-hoc discovery module 202 to discover network proxies that may reside on an ad-hoc network. For example, the ad-hoc discovery module 202 may employ Web Services Dynamic Discovery (WS-Discovery), NetBIOS Frames (NBF), NetBIOS Extended User Interface (NetBEUI), and/or Simple Service Discovery Protocol (SSDP) to query the network participants using an ad-hoc peer-to-peer network protocol.

By way of example and not limitation, a client may employ WS-discovery to determine a proxy's location on an ad-hoc peer-to-peer network. Specifically, when a client joins an ad-hoc network, it listens on the network for announcement messages as various services and resources join and then leave the ad-hoc network.

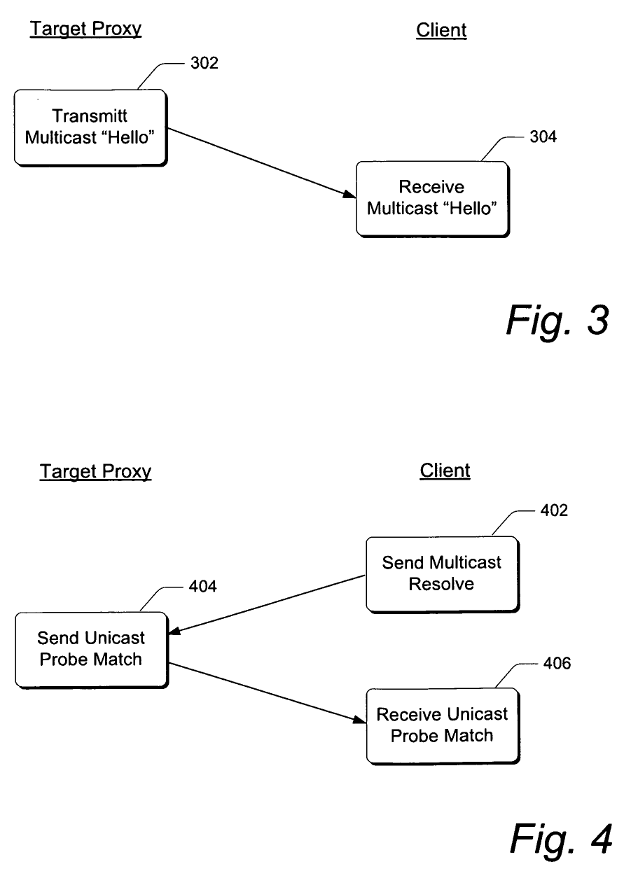

Referring to FIG. 3, when a proxy joins a network, it may send an announcement message (e.g., “Hello” message) to a multicast group, at step 302. By listening to the multicast group, a client (e.g., ad-hoc discovery module 202) can detect the presence of the new proxy, receive the multicast “Hello”, and record the proxy's domain name, IP address, or any other proxy information in memory, at step 304. Moreover, once a proxy has been discovered, the ad-hoc discovery module 202 may query the proxy for additional information (e.g., types and locations of network services).

Alternately or additionally, a client may wish to find a specific proxy on the ad-hoc network. Accordingly, the ad-hoc discovery module 202 may send the proxy a “resolve” message or a “probe” message and listen for a “resolve match” message or a “probe match” message from the targeted proxy.

Referring to FIG. 4, when a client desires a specific service or type of service, the ad-hoc discovery module 202 can send a multicast “resolve message” to the multicast group, at step 402. The proxies that match the probe message can respond by sending a “probe match” message directly to the client (e.g., ad-hoc discovery module 202), at step 404. The client can then record the proxy's address or other proxy information in memory at step 406.

Returning to FIG. 2, the infrastructure discovery module 204 may also employ Dynamic Host Configuration Protocol (DHCP) to obtain a network proxy's address or other information.

In general, when a DHCP configured client joins a network, the client may send a broadcast query to a DHCP server requesting an IP address. The DHCP server manages a collection of IP addresses and configuration parameters such as the client's default gateway, domain name, DNS server, etc. Upon receiving the broadcast query, the DHCP server assigns the client an IP address, a lease duration (i.e., length of time the IP address is valid), a subnet mask, and a default gateway. The query is typically initiated after the client device is rebooted.

To identify the location of a network proxy (e.g., DHCP client), a field identifying the location of a network proxy may be included in the DHCP messages. Accordingly, when a client joins a network, a DHCP server assigns the client an IP address and an identifier (e.g., DHCP special option) identifying where to look for the proxy. Accordingly, when a client, such as computing device 102 of FIG. 1, joins a network it is provided with an identifier, such as an IP address, a domain name, or other identifier, identifying where a proxy is located. The client simply uses the information in the special identifier to locate the proxy.

In general, a device's address is “static” when a computing device is configured with the same address each time it is booted-up. A static address, such as a hostname and the like, is typically assigned by a system administrator; however it may be assigned by an internet service provider (ISP) or the computing device's own operating system. Static addressing is typically used so that a network resource (e.g., network printer, network server, domain name directory, etc.) can be found by its host or domain name.

The static configuration module 206 can be configured as a software module that searches a file or network directory 214 (e.g., Lightweight Directory Access Protocol (LDAP), Active Directory, etc.) for proxies using the proxy's name, description, or affiliation (e.g., domain name, organizational name, directory, user group, etc.). For example, a user can enter a proxy's name and the static configuration module 206 can query the file or network directory 214 to discover a proxy's address. Once the UPLM 110 has the proxy's address, it can employ other mechanisms to further resolve the proxy. For example, the UPLM 110 may use Domain Name System (DNS) to resolve a host name into an IP address or lightweight directory access protocol (LDAP) to retrieve a host name for a LDAP resource. To illustrate, the static configuration module 206 may query network directory 214 to retrieve all the proxies on a subnet, such as, for example Subnet A of FIG. 1. The UPLM 110 may then query a LDAP server for other information regarding the proxies on Subnet A (e.g., hostname). The static configuration module 206 may then cache the proxy information in memory for later use.

In summary, the Unified Proxy Location Module 110 may discover the proxies on a network through ad-hoc discovery, infrastructure discovery, and/or by searching network directories.

It should be appreciated that some proxies may not be secure and could potentially subject a client, such as computing device 102 of FIG. 1, to various types of attacks (e.g., send altered messages, fraudulent messages, duplicate messages, etc.). Moreover, proxies may also eavesdrop on the dataflow between a client device and a network service.

Accordingly, a proxy residing on an open public network may be less secure than a proxy that resides on a local area network or company intranet. Moreover, the way in which a proxy is discovered can be just as important as where the proxy resides. For example, peer-to-peer protocols can be less secure than administrative provisioning mechanisms (e.g., LDAP, DHCP, etc.).

Generally, policies 208 are rules that enable or disable proxies and/or proxy messages based in part on the proxy's location, identity, or the method used to discover the proxy. For example, one policy could be that if a client resides on a different administrative domain than the proxy, the client should not trust the proxy. A second policy might be that if a client cannot verify the proxy's identity (e.g., through a signature contained in the target proxy's probe match message as illustrated FIG. 4) the client should not trust the proxy. A third policy might be that if a proxy was discovered through ad-hoc peer-to-peer discovery the proxy should not be trusted. Moreover, a policy could be a combination of other policies. For example, a proxy that was discovered through an ad-hoc discovery process may not be trusted unless the proxy's identity can be authenticated.

Alternatively, a policy can be used to disable a discovery module (e.g., ad-hoc discovery module, infrastructure discovery module, static configuration module, etc.). For example, if the computing device was connected to an unsecure public access point, such as the Internet, the UPLM generally should not accept results from the ad-hoc discovery module 202.

In summary, the computing device's operating system, a software module residing on the device, and/or the UPLM 110 itself, may apply one or more policies 208 which may prevent the UPLM 110 from trusting a proxy if, for example, the proxy resides on a different administrative domain, the proxy cannot be authenticated, or the proxy was discovered through a less trusted method or means.

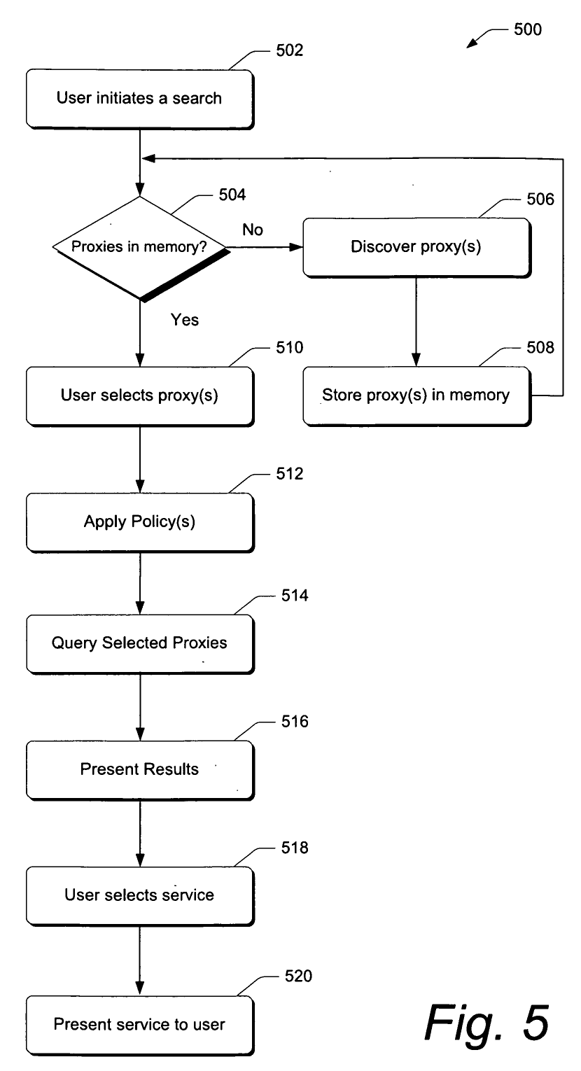

FIG. 5 is a flow diagram describing steps in a method 500 in accordance with one or more embodiments. The method can be performed in connection with any suitable hardware, software, firmware, or combination thereof. In at least some embodiments, aspects of the method can be performed by a software component such as the unified proxy location module (UPLM) 110 described in FIG. 2.

At step 502, a network user initiates a search for a network service or resource. For example, the user could be looking for an E-mail server, a network printer, a data server, a software library, or an online commerce site, to name a few. The user may initiate the search by reviewing one or more proxies that have been cached in the user's personal computer. In one embodiment, the proxies that meet or comply with the various policies are displayed as icons on a graphical user interface (GUI). In an alternate embodiment, the proxies are displayed as an indented list, a hierarchal tree structure, or any other suitable presentation format. In a further embodiment, a query is sent to every proxy that passes a policy check, and the user is not involved.

However, there can be situations when a network proxy has not been discovered or stored in memory. For example, the proxy may have recently joined the network, the proxy may have only recently come on-line, or the proxy may have changed network locations. Moreover, there can be situations where the user is unable to find a proxy that has been stored in memory. For example, a proxy may have been renamed or assigned a new DNS name or IP address.

At step 504, if a user desires a specific proxy or type of proxy and there is not an appropriate proxy in memory, the UPLM may discover new or additional proxies. The UPLM may listen on various subnets for proxies to announce themselves (e.g., ad-hoc discovery), the UPLM may search the various network directories for proxies (e.g., static configuration), and/or search for proxies using a proxy identifier (e.g., infrastructure discovery), at step 506.

At step 508, the UPLM can store the discovered proxy(s) in memory. The proxy(s) could be organized based on subnet, network domain, network service or resource, or any other suitable method of organizing network proxies.

If the desired proxy has been manually entered into the system, the desired proxy can be presented to the user. Alternatively, the user may select one or more proxies by clicking on a proxy icon, entering a proxy's address, or any other means of selecting a proxy, at step 510. A window may then open up revealing the selected proxy and a list of network services, resources, and/or devices associated with the proxy. For example, a proxy may be associated with a network printer and the user may wish to know the printer's capabilities (e.g., paper size, color, throughput, etc.), the printer's location, or any other information associated with the network printer.

At step 512, the computing device's operating system may apply one or more policies to the communications between the client (e.g., unified proxy location module) and the selected proxies. For instance, a security policy may be used to disable certain UPLM modules. Such as, when a user indicates that their current network is “Public”, an ad-hoc search may not be performed. A policy may prevent the UPLM from interacting with messages from the proxies if, for example, the proxies reside on a different administrative domain or the proxy cannot be authenticated.

At step 514, the UPLM queries the selected proxies to determine something about a network service, resource, and/or device. For example, the UPLM may query the selected proxy to determine the printer's type, location, or other printer properties.

At step 516, the results of the proxy query are presented to the user. For example, the proxy can direct the computing device, such as computing device 102 of FIG. 1, how to find a network printer. The computing device can then connect to the printer to determine the status of the user's print job. Note that at this point communications between the computing device and proxy are generally complete, and that the computing device and network service provider communicate directly.

At step 518, the user may select a network service based on the results of the proxy query. For example, when learning that the network printer has completed their print job, the user may send the network printer a presentation to be printed and bound for a customer presentation the next day.

At step 520, the selected service is presented and/or provided to the user. For example, after the proxy communication is complete, in the case of a printing service, a customer presentation could be printed and bound, and a notification sent to the user that the print job is complete. In the case of an E-mail application, the application could retrieve the user's E-mail messages from an E-mail server and present the messages to the user.

It should be appreciated that the UPLM consolidates the proxy searching or discovery function in a single software module or application. This benefits software applications residing on a network client because they can now go to a single location to access a network service, resource, and/or device. Moreover, the UPLM can discover network proxies independently of the software applications that may use them. The software applications may be unaware of how the UPLM discovered the network proxies and the network services, resources, and/or devices that they represent.

Having described example embodiments in which a unified proxy location module employs various techniques to efficiently discover network proxies, the discussion now shifts to an example computing device capable of implementing the described embodiments.

Example System

FIG. 6 illustrates an example computing device 600 that can implement the various embodiments described above. Computing device 600 can be, for example, computing device 102 of FIG. 1, or any other suitable computing device.

Computing device 600 may include one or more processors 602, one or more memory and/or storage components 604, one or more input/output (I/O) devices 606, and a bus 608 that allows the various components and devices to communicate with one another.

Bus 608 represents many types of bus structures, including a memory bus or memory controller, a peripheral bus, an accelerated graphics port, or a local bus employing a variety of bus architectures.

Memory/storage component 604 represents one or more computer storage devices or storage media. The memory component 604 can include volatile media (such as random access memory (RAM)) and/or nonvolatile media (such as read only memory (ROM), Flash memory, optical disks, magnetic disks, and the like). The storage component 604 can include fixed media (e.g., RAM, ROM, a fixed hard drive, etc.) as well as removable media (e.g., a Flash memory drive, a removable hard drive, an optical disk, and so forth).

One or more input/output devices 606 enable a user to enter commands and information into the computing device 600, and allows information to be presented to the user and/or other components or devices. For example, input device 606 may include a keyboard, a pointing device (e.g., a mouse), a microphone, and a scanner, and so forth. Output device 606 may include a display device (e.g., a monitor or projector), speakers, a printer, and a network card, to name a few.

Various techniques may be described herein in the context of software or program modules. Generally, software includes applications, routines, programs, objects, components, data structures, and so forth that perform tasks or implement abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

Conclusion

Various embodiments enable network users to efficiently discover network proxies.

In at least some embodiments, a computing device may employ various techniques to discover and collect network proxies. A user, through a network client or client device, can select one or more proxies from the collected proxies and then query the selected proxies for information related to a network service or resource. The user can then select a network service or resource based in part on the proxy information.

Although the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter

What is claimed is:

1. A method of discovering a network proxy, comprising:
discovering one or more network proxies, wherein the one or more network proxies are discovered by employing more than one technique;
receiving one or more proxy selections from a user, wherein the one or more proxy selections are selected from one or more discovered network proxies; and
querying one or more discovered network proxies selected by the user for information related to one or more network services.

2. A method as recited in claim 1, wherein the more than one technique to discover network proxies comprises ad-hoc discovery, infrastructure discovery, and/or static configuration discovery.

3. A method as recited in claim 1, wherein discovering one or more network proxies comprises discovering a proxy's network address and information related to network services associated with the proxy.

4. A method as recited in claim 1, wherein one or more proxies can be selected by selecting one or more icons representing the one or more proxies.

5. A method as recited in claim 1, further comprising presenting network service information to the user or another application.

6. A method as recited in claim 5,wherein the network service information comprises one or more of a description of a network service, a description of a networked device, or a description of a network resource.

7. A method as recited in claim 5, further comprising receiving one or more network services based in part on the network service information.

8. A method as recited in claim 1, further comprising applying one or more policies to the one or more proxies, wherein the one or more policies are associated with a device state, a proxy state, a relationship between a device and a proxy, and/or a method used to discover a proxy.

9. A method as recited in claim 1, further comprising receiving one or more messages from one or more network services selected by the user, wherein an application receiving the one or more messages may be unaware of how the one or more network services were discovered.

10. One or more computer-readable storage media embodying computer executable instructions, which when executed by one or more processors perform a method, comprising:
discovering one or more network proxies, wherein the one or more network proxies are discovered by employing more than one technique;
receiving one or more proxy selections from a user, wherein the one or more proxy selections are selected from one or more discovered network proxies;
querying one or more discovered network proxies selected by the user for information related to one or more network services;
presenting network service information to the user;
receiving one or more network service selections from the user based in part on the network service information; and
presenting one or more network services to the user in response to the one or more network service selections.

11. One or more computer-readable storage media as recited in claim 10, wherein the more than one technique to discover network proxies comprises at least ad-hoc discovery, infrastructure discovery, and static configuration discovery.

12. One or more computer-readable storage media as recited in claim 10, wherein discovering one or more proxies comprises discovering a proxy's network address and information related to network services associated with the proxy.

13. One or more computer-readable storage media as recited in claim 10, wherein the network service information comprises one or more of a description of a network service, a description of a networked device, and/or a description of a network resource.

14. One or more computer-readable storage media as recited in claim 10, further comprising applying one or more policies to the one or more proxies, wherein the one or more policies is associated with a relationship between a device and a proxy, a method used to discover a proxy, whether a proxy's identity can be verified, and/or a discovery module used to discover a proxy.

15. One or more computer-readable storage media as recited in claim 10, further comprising receiving one or more messages from the one or more network services, wherein an application receiving the one or more messages is unaware of how the one or more network services were discovered.

16. A system for discovering a network resource, comprising:
a computer processor; and
computer readable storage media, wherein the computer readable storage media comprises computer readable instructions that when executed by the processor, cause the processor to:
discover one or more proxies from one or more networks by employing more than one discovery technique;
store network service information associated with the one or more discovered proxies in memory; and
monitor the one or more networks for additional proxies.

17. A system as recited in claim 16, wherein the more than one discovery technique comprises at least ad-hoc discovery, infrastructure discovery, and static configuration discovery.

18. A system as recited in claim 16, wherein the system monitors the one or more networks for additional proxies by listening on one or more subnets.

19. A system as recited in claim 16, wherein the system monitors the one or more networks for additional proxies by querying one or more network infrastructures.

20. A system as recited in claim 16, further comprising updating memory by adding network service information associated with the additional proxies.
